(19) United States
(12) Patent Application Publication
(10) Pub. No.: US 2005/0132416 A1
(43) Pub. Date: Jun. 16, 2005

(54) Remote control having a print button function

(76) Inventor: Louise Mary Wasilewski, Atlanta, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/051,387

(22) Filed: Feb. 4, 2005

Related U.S. Application Data
(63) Continuation of application No. 09/792,774, filed on Feb. 23, 2001.

(51) Int. Cl. H04N 7/173; H04N 11/00; H04N 7/00; H04Q 7/20; H04N 7/16; H04N 7/18

(52) U.S. Cl. 725/133; 725/100; 725/80; 348/552; 725/141

(57) ABSTRACT

Included is a radio for delivering and receiving information, the radio configured for receiving and delivering information. The radio may include a radio receiver for receiving audio signals and embedded data that is associated with the audio signals, the radio receiver further configured for receiving commands from a user. The radio may also include a printer interface configured to communicate a information associated with the embedded data to a printer. Upon reception of a command from the user, the information associated with the embedded data may be provided to a printer for printing.

### CROSS-REFERENCE TO RELATED APPLICATION

This application is a continuation of application Ser. No. 09/792,774, filed Feb. 23, 2001, which is entirely incorporated herein by reference.

### FIELD OF THE INVENTION

This invention relates generally to the transmission of wireless infrared (IR) signals indicative to a print function from an electrical device, and more specifically to a print button on a remote control to print embedded data information.

### BACKGROUND OF THE INVENTION

With the advent of the digital broadband delivery systems, such as cable television systems, and satellite system providers, advanced services are being offered to subscribers, such as video-on-demand, e-mail, interactive advertising, Internet access, and other services. At this time, a cable television operator typically sends information that can only be seen and heard a television. For some applications, such as e-mail and Internet access, a keyboard is provided to enable the subscriber to enter alphanumeric information.

The keyboards allow a subscriber to interactively alter the viewing screen. For example, a subscriber may type an e-mail that is typically displayed on the screen, and then the subscriber may send the e-mail message to other users. At this time, however, data providers, such as the cable television providers and satellite system providers, can deliver much more information than the conventional video, audio, and data that is associated with an event and shown on the viewing screen. More specifically, a provider can include an embedded data portion associated with an event, such as a blueprint, recipe, or instructions, that is not shown on the screen. Conventionally, however, if the data portion is embedded into the event and not shown, then the subscriber has had no way of accessing this information even with the use of a keyboard or a remote control.

Thus, what is needed is a device that gives the subscriber the ability to access an accompanying data portion associated with an event that may be provided from a service provider.

### SUMMARY

Included is a radio for delivering and receiving information, the radio configured for receiving and delivering information. The radio may also include a radio receiver for receiving audio signals and embedded data that is associated with the audio signals, the radio receiver further configured for receiving commands from a user. The radio may include a printer interface configured to communicate a information associated with the embedded data to a printer. Upon reception of a command from the user, the information associated with the embedded data may be provided to a printer for printing.

### BRIEF DESCRIPTION OF THE DRAWINGS

FIG. 1 is a block diagram of a cable television system in which the present invention may be employed.

FIG. 2 is a block diagram representation of an MPEG transport packet.

FIG. 3, consisting of FIG. 3A and FIG. 3B, illustrates the relationship between MPEG tables and an MPEG transport stream.

FIG. 4 is a block diagram representation of a modulator for modulating MPEG bit streams.

FIG. 5 is an illustration of an infrared (IR) remote control with a print button for communicating with a set-top receiver in accordance with the present invention.

FIG. 6 is an illustration of an IR remote control of FIG. 5 for communicating with a set-top receiver.

FIG. 7 is a flowchart depicting the printing operation in accordance with the present invention.

### DETAILED DESCRIPTION

The present invention provides a print button located on a keypad infrared (IR) remote control to enable a printer in connection with a set-top receiver to print a data portion associated with an event that may be embedded within the event stream or shown on a presentation device, such as a television or computer, along with the event. It will be appreciated that the presentation device presents information related to the event to a user in a user-detectable format, such as video or audio. U.S. Pat. No. 6,161,011 to Loveless, the teachings of which are incorporated herein by reference, shows a hybrid fiber coax communications system that could be used to implement the present invention. It will be appreciated, however, that the communications systems can also include satellite, UHF/VHF, local multi-channel distribution system (LMDS), or multi-channel multi-point distribution system (MMDS). Additionally, a print button can be included on a conventional keyboard for communicating with a set-top receiver to print the data portion.

Television System Overview

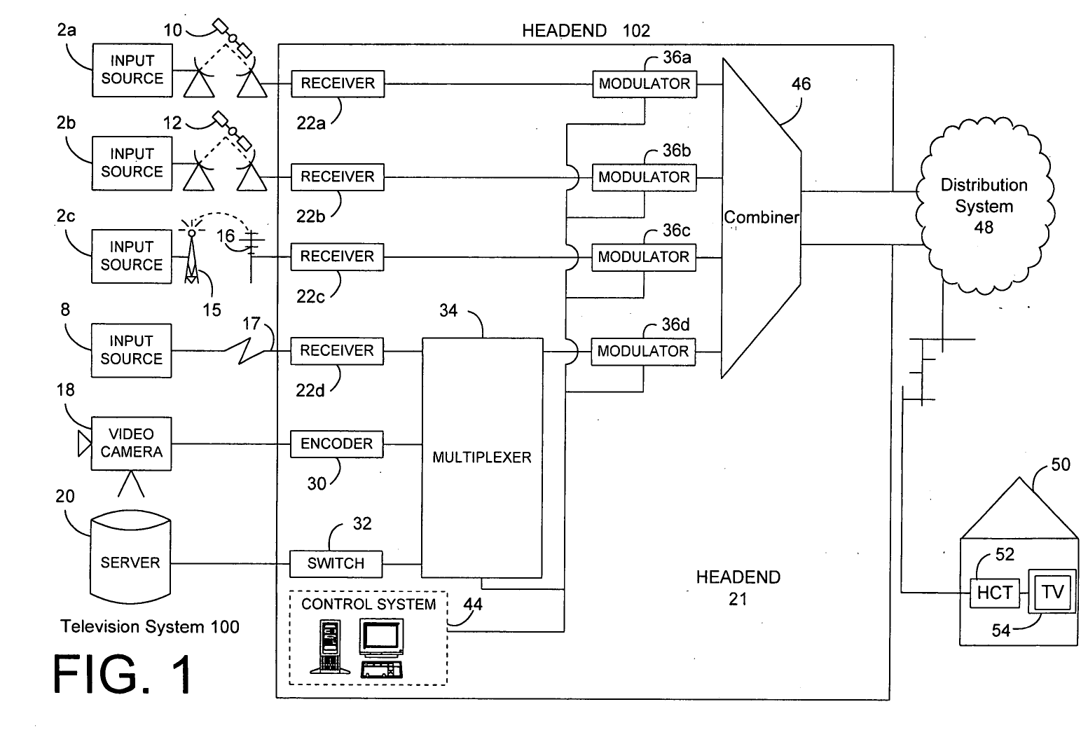

FIG. 1 illustrates various aspects of an exemplary cable television system in which the present invention is designed to operate. Those skilled in the art will understand that while digital equipment and signaling are highlighted in the following examples, analog equipment of combinations of analog and digital equipment and signaling can be used throughout a television system. For example a modulated output signal could be an analog signal.

The television system 100 includes a headend 21, which receives input programming from multiple input sources. The headend 21 combines the programming from the various sources and distributes the programming to subscriber locations (e.g., subscriber location 50) via distribution system 48.

In a typical system, the headend 21 receives programming from a variety of sources 2a, 2b, 2c. The programming signals may be transmitted from the source to the headend via a variety of transmission paths, including satellite paths 10, 12, and terrestrial broadcast paths 15, 16. The headend 21 can also receive programming from a direct feed source 8 via a direct line 17. Other input sources include a video camera 18 or a server 20. The signals provided by the programming sources can include a single session or a multiplex that includes several sessions. Programmers and television system operators both employ forms of conditional access, or encryption, to prevent piracy and ensure that those who have subscribed to and paid for their services are only receiving their signals. For example, programmers employ conditional access to ensure that those television system operators that pay for their programming only decrypt their transmissions. Similarly, television system operators can use conditional access to prevent “pirates” from receiving premium channels or pay-per-view programming for which they have not paid. Thus, a signal from a programmer may be decoded using “incoming” conditional access, and then encoded for transmission to the subscribers using “outgoing” conditional access. An example of a conditional access system that may be used in television system 100 is disclosed in commonly assigned, co-pending U.S. patent application Ser. No. 60/054,575 filed Aug. 1, 1997, entitled “Conditional Access System”, the disclosure of which is incorporated herein by reference.

The headend 21 includes a plurality of receivers 22a, 22b, 22c, 22d that are each associated with an input source. MPEG encoders, such as encoder 30, are included for encoding such things as local programming or a video camera feed. A switch 32 provides access to server 20, which could be a pay-per-view server, a data server, an Internet router, a network system, or a telephone system. Some of the signals may require additional processing, such as signal multiplexing prior to being modulated. Such multiplexing is done by multiplexer 34.

The headend 21 contains a plurality of modulators 36a, 36b, 36c, and 36d for interfacing with the distribution system 48. The modulators convert the received programming information into a modulated output signal suitable for transmission over the distribution system 48. The output signals from the modulators are combined, using equipment such as a combiner 46, for input into the distribution system 48.

A control system 44 allows the television system operator to control and monitor the functions and performance of the television system 100. The control system 44 interfaces, monitors, and/or controls a variety of functions, including the channel lineup for the television system, billing for each subscriber, and conditional access for programming distributed to subscribers. Control system 44 provides input to the modulators for setting operating parameters, such as system specific MPEG table packet organization or conditional access information. The control system 44 can be located at headend 21 or remotely.

The distribution system 48 distributes signals from the headend 21 to subscriber locations, such as subscriber location 50. The distribution system 48 could be an optical fiber network, a coaxial cable network, a hybrid fiber-coaxial network, a satellite system, an off-air VHF/UHF network,, a direct broadcast system, or similar alternatives. There is a multitude of subscriber locations connected to distribution system 48. At subscriber location 50, a decoder 52, such as a digital home communications terminal (DHCT), decodes the signals for display on a display device, such as on a television set (TV) 54 or a computer monitor. Those skilled in the art will appreciate that the signal can be decoded by a variety of equipment, including a DHCT, a computer, a TV, a monitor, or a satellite receiver.

Moving Pictures Experts Group (MPEG) Overview

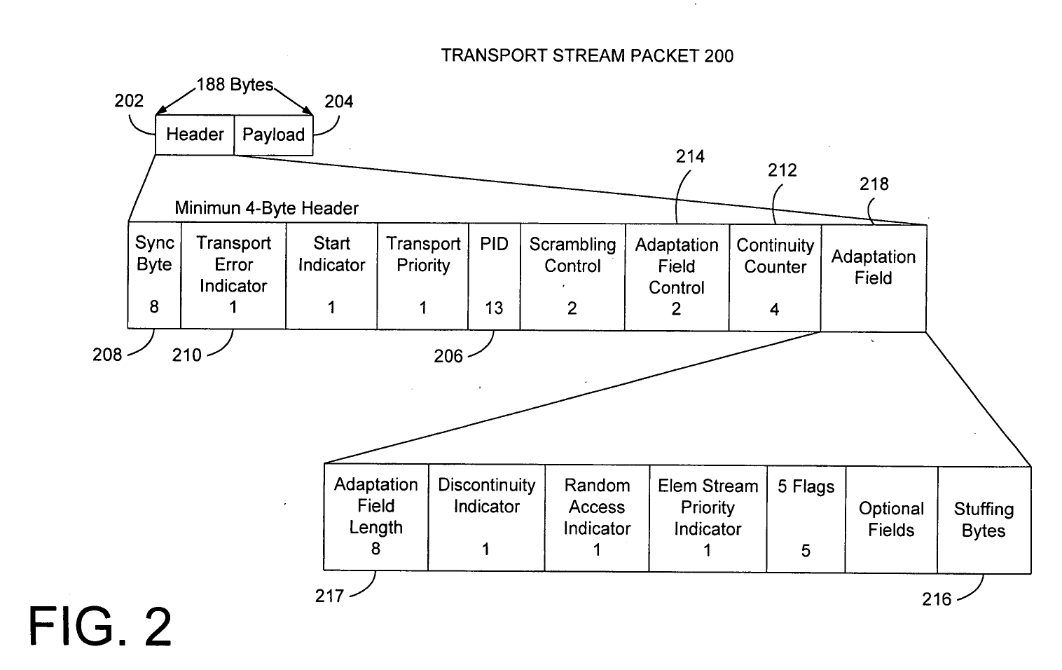

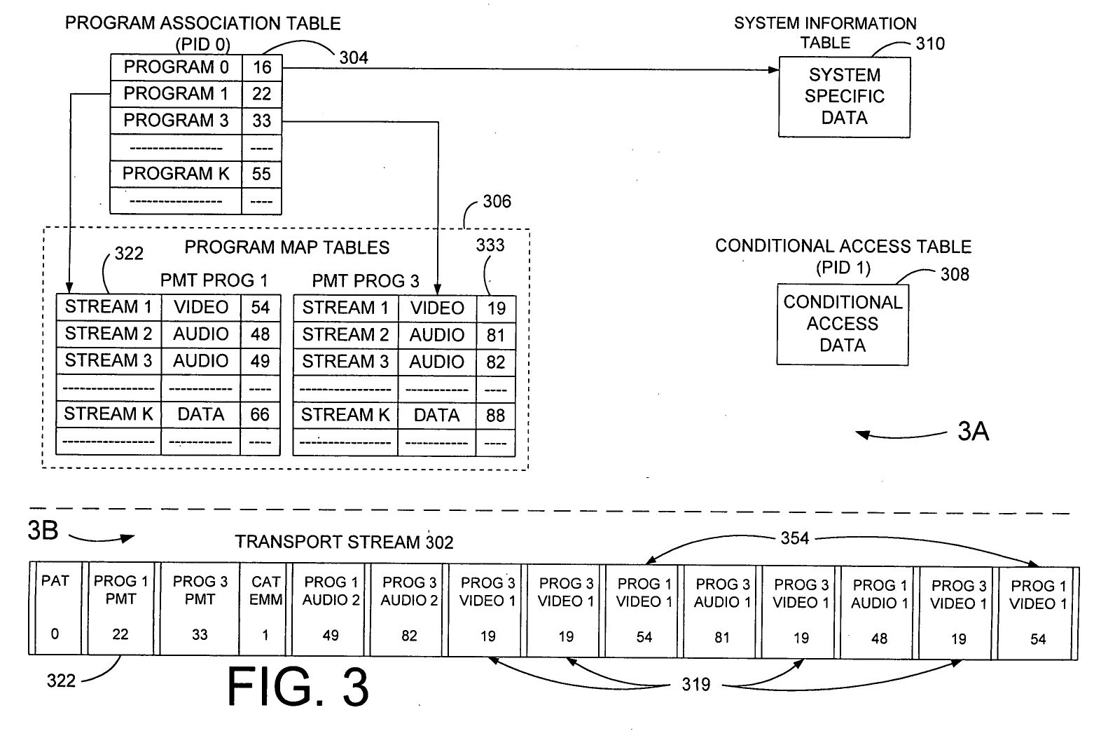

The Moving Pictures Experts Group (MPEG) was established by the International Standards Organization (ISO) for the purpose of creating standards for digital audio/video compression. The MPEG experts created the MPEG-1, MPEG-2, and MPEG-4 standards, with the MPEG-1 standard being a subset of the MPEG-2 standard. The combined MPEG-1 and MPEG-2 standards are hereinafter referred to as MPEG. In an MPEG encoded transmission, programming and other data are transmitted in packets, which collectively make up a transport stream. An MPEG transport stream includes table packets, which provide information about the organization of the transport stream and about any conditional access scheme that is used. Additional information regarding transport stream packets, the composition of the transport stream, types of MPEG tables, and other aspects of the MPEG standards are described below. In addition, FIG. 2 and FIG. 3 provide a graphical representation of MPEG information. In an exemplary embodiment, the present invention employs MPEG table packets. However, the present invention is not so limited, and can be implemented using other types of data, for example, data provided from a programming guide.

As mentioned above, an MPEG transport stream is made of packets, where each packet is identified by a packet identifier (PID). All of the packets associated with a single source, e.g., all video packets or all audio packets for a source, will include the same PID. In general, table packets are used to indicate which PIDs are associated with each program in the transport stream. So, for example, a table packet might indicate that the transport stream includes two programs, where program 1 consists of the packets with a PID of 31, and program 2 consists of the packets with PIDs of 45 and 63, for example, a television show including video 45 and audio 63. Additional information regarding the makeup of an MPEG transport stream and its various components is provided below.

Packetized Elementary Stream (PES)

The output of a single MPEG audio or video encoder 30 (of FIG. 1) is an Elementary Stream, which is an endless, near-real-time signal. The Elementary Stream is broken into packets in what is referred to as a Packetized Elementary Stream (PES). These packets include header information to identify the start of the packets and must include time stamps because packetizing disrupts the time axis.

One video PES and a number of audio PESs can be combined to form a program, provided that all of the encoders are locked to a common clock. Time stamps in each PES ensure correct correlation, or lip-sync, between the video and audio. Data may also be included with or without time stamps.

Transport Stream Packet

A Transport Stream is a multiplexed stream that may include several programs, which are transported in fixed size, 188 byte, transport stream packets 200 (FIG. 2). FIG. 2 illustrates a transport stream packet 200, including a minimum 4 byte header 202 and a payload 204. The header 202 is further expanded to illustrate the parts thereof. The numbers at the bottom of the cells, such as the “8” in Sync Byte field 208, indicate the fixed bit size of the cell. Cells with no number, such as payload 204, do not have a fixed size. In header 202, the most important information is:

Sync Byte cell 208, which is recognized by a demultiplexer or decoder so that alignment to the start of a packet can be determined.

Transport error indicator cell 210, which is set if the error correction layer above the transport layer is experiencing a raw bit error rate (BER) that is too high to be correctable. It indicates that the packet may contain errors.

Packet Identifier (PID) cell 206, which is a thirteen-bit code used by a de-multiplexer or decoder to distinguish between different types of packets.

Continuity counter cell 212, which is a four-bit value that is incremented by the encoder as each new packet having the same PID is sent. It is used to determine if any packets are lost, repeated, or out of sequence.

Header 202 also includes a start indicator cell, a transport priority cell, a scrambling control cell, an adaptation field control cell 214, and an adaptation field cell 218. Included within the adaptation field cell 218 is an adaptation field length cell 217, a discontinuity indicator cell, a random access indicator cell, an elementary stream priority indicator cell, a 5 flags cell, an optional fields cell, and a Stuffing Bytes cell 216.

In some cases more information is needed in header 202. The header can be expanded using adaptation field cell 218. If header 202 is expanded, payload 204 becomes smaller to maintain the fixed packet size of 188 bytes.

Stuffing Packets

When the required bit rate or packet size is less than the fixed bit rate or fixed packet size, the excess capacity is filled by inserting stuffing. Stuffing can be used in two ways, as stuffing bytes or as a stuffing packet. Stuffing bytes can be used with a partial payload to fill up the remainder of transport stream packet 200 to maintain the fixed packet size. Stuffing bytes can be in the payload 204 or in the Stuffing Bytes cell 216 of an expanded header 202. A stuffing packet, which is a transport stream packet 200 with only a header and stuffing, can be used in a fixed rate bit stream to maintain the fixed bit rate. The stuffing packet is used to fill unused or excess capacity. Stuffing packets are always identified by PID 8191, or thirteen Is. Demultiplexers and decoders ignore packets thus identified as stuffing packets. Stuffing can be all ones (1), all zeros (0), pseudo-random 1s and 0s, or an ignore flag followed by any of the other options.

Transport Stream (TS)

Several programs and their associated PESs are multiplexed to form a single Transport Stream (TS) 302 (FIG. 3). A Transport Stream 302 differs from a program in that the PES packets are further subdivided into short fixed-size (i.e., 188 byte) transport stream packets 200 and in that multiple programs encoded with different clocks can be carried. A TS also contains table information that is described below. This is possible because a transport stream 302 has a program clock reference (PCR) mechanism that allows transmission of multiple clocks.

The fixed-size transport stream packets 200 of Transport Stream 302 each contain 188 bytes. The transport stream 302 may carry many different programs. In advanced applications, each program may use a different compression factor and a bit rate that can change dynamically even though the overall bit rate for Transport Stream 302 may stay constant. Called statistical multiplexing, this advanced application allows a program temporally requiring a larger bandwidth to utilize bandwidth from a program that is not using all of its allocated bandwidth. In addition, each video PES could have a different number of audio and data PESs associated with it. With this flexibility in the makeup of Transport Stream 302, a decoder or demultiplexer must be able to change from one program to the next and correctly select the appropriate audio and data channels. This changing and selecting is facilitated by MPEG tables described herein below.

A Transport Stream 302 is more than just a multiplex of audio and video packets. In addition to the compressed audio, video, and data, Transport Stream 302 includes a great deal of information that describes the bit stream. This information is found in MPEG tables such as Program Specific Information tables or System Information tables, which describe the relationships of the MPEG packets and identify their corresponding packet identifier (PID). Some of this information may or may not be presented to the subscriber. Each packet carries a PID 206 (see FIG. 2) located in the packet header 202. The MPEG tables list the PIDs for all packets associated with a particular program. The PIDs are used by the decoder or demultiplexer to change from one program to the next and correctly select the appropriate video, audio, and data channels. FIG. 3, including FIG. 3A and FIG. 3B, illustrates the relationship between the transport stream 302, the MPEG packets and tables therein, and the function of PIDs. Illustrative of the function of PIDs, they can be used to locate the associated tables in FIG. 3A or the corresponding packets in FIG. 3B.

FIG. 3A, the upper portion of FIG. 3, represents the different MPEG tables in the MPEG transport stream 302. For example, Program Association Table 304 indicates that packets with a PID of 22 may contain Program Map Tables (PMT) associated with program 1. The PMT 322 that has a PID of 22 indicates the PIDs of the packets that make up the various components of the stream associated with program 1.

FIG. 3B, the lower portion of FIG. 3, represents the MPEG packets found in a typical MPEG transport stream 302. The MPEG packets are labeled and display their corresponding PIDs. The PIDs can identify an associated table of FIG. 3A. For example, in FIG. 3B, the packet 322, which has a PID of 22, corresponds to the PMT 322 of FIG. 3A.

Program Specific Information (PSI)

A demultiplexer or decoder can correctly select packets only if it can correctly associate them within the transport stream 302 to which they belong. A demultiplexer or decoder can do this task only if it knows what the right PIDs are. This is the function of the Program Specific Information (PSI) tables.

The PSI includes the Program Association Table (PAT) 304, the Conditional Access Table (CAT) 308, and the Program Map Table (PMT). In FIG. 3A, two PMTs are shown, Program 1 PMT 322 and Program 3 PMT 333.

The PSI tables are carried in packets having unique PIDs, some of which are standardized and some of which are specified by the PAT 304 and the CAT 308. These table packets must be repeated periodically in every transport stream. The PAT 304 always has a PED of 0, the CAT 308 always has a PID of 1, and stuffing packets always have a PID of 8191. These are the only fixed PIDs in the MPEG system. The demultiplexer or decoder must determine all of the remaining PIDs by accessing the appropriate table(s).

The Program Association Table (PAT) 304 lists every program in transport stream 302. The PAT 304 identifies the PID for the packets containing the associated Program Map Tables (PMT) 306. For example, PAT 304 identifies all packets with PID 22 as being a PMT 322 associated with program 1.

PIDs of all video, audio, and data elementary streams that belong in the same program stream are listed in a PMT 306 with their associated PIDs. For example, PMT 322 lists a video stream, two audio streams, a data stream, and other elementary streams belonging to program 1. PMT 322 also identifies the associated PIDs for each stream, such as PID 54 for all program 1 video packets.

In FIG. 3, the PAT 304 identifies PID 33 for all program 3 PMT 333 packets. In the corresponding PMT 333, elementary stream 1 identifies as a video stream all packets with a PID value of 19. All program 3 video 1 packets, in transport stream 302, have PID 19 as indicated by arrows 319 of FIG. 3B. PMT 322 indicates that all video packets associated with program 1 have PID 54. These packets are indicated by arrows 354 in transport stream 302 of FIG. 3B. The decoder (or a demultiplexer) can select all data for a given elementary stream by accepting only packets with the right PID, such as PID 19 for elementary stream 1 video, and rejecting the remainder. Data for an entire program can be selected using the PIDs in a PMT. For example, for the entire program 3, using PMT 333, select all video 19 PIDs, audio 81 PIDs, audio 82 PIDs, and data 88 PIDs. Packet-continuity counts ensure that every packet that is needed to decode a stream is collected. In some systems, some or all of the programs are protected or tiered so that only those who have paid a subscription or fee can view them. Then the transport stream 302 contains conditional access information, Conditional Access Table (CAT) 308, to administer this protection, located at PID 1 and labeled EMM in transport stream 302. The PIDs for Entitlement Management Messages (EMM) are listed in the CAT 308 packets (PID=1).

Consequently, if the decoding of a particular program is required, reference to the PAT 304 and then a PMT 306 is all that is needed to find the PIDs of all of the elementary streams in the program. If the program is encrypted, then access to the CAT 308 may also be necessary.

The first entry in the PAT 304, session 0, indicates the PID of the System Information Table 310.

System Information Table

A given System Information Table 310 contains details of more than just the transport stream 302 carrying it or the PSI of the transport stream. The System Information Table 310 may also include details of other transport streams that may be available to the same decoder, for example, by tuning to a different RF channel or steering a dish to a different satellite. The System Information Table 310 may list a number of other transport streams and each one may have a descriptor that specifies the radio frequency, orbital position, and so on. System Information Table 310 provides information describing the overall system signal(s) of a specific television system 100.

Types of a System Information Table 310 include a Digital Video Broadcast (DVB) standard Network Information Table (NIT) and an Advanced Television Systems Committee (ATSC) standard System Information (SI) table. DVB and ATSC transport streams may also contain additional service information.

Those skilled in the art will appreciate that FIGS. 1-3 are intended to provide a brief, general description of a typical television system and MPEG encoded data, and that additional information is readily available from a variety of sources.

Modulator Overview

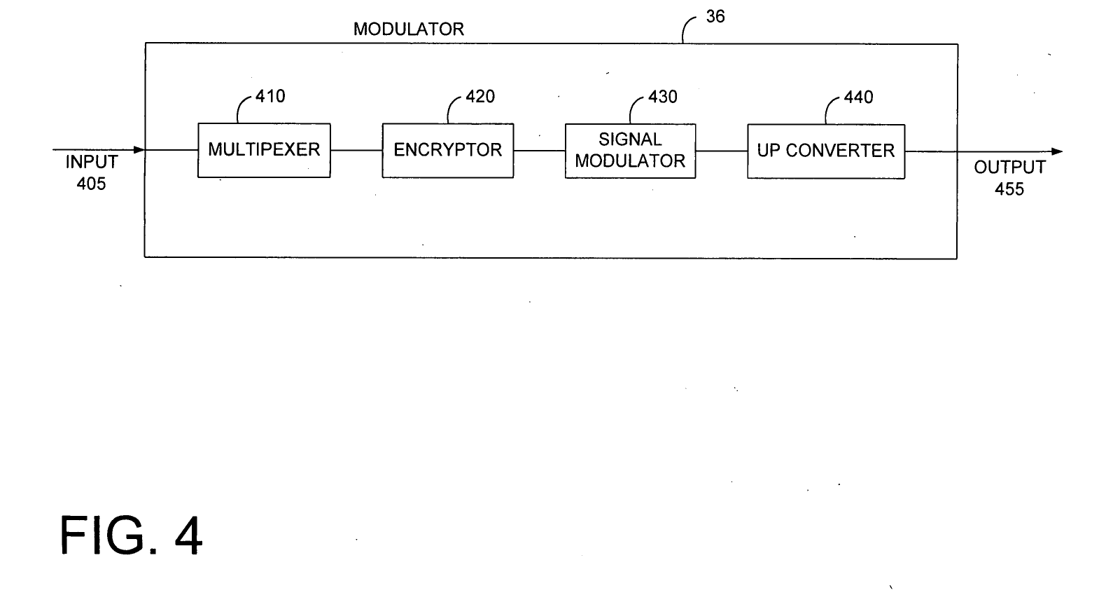

FIG. 4 is a block diagram of a modulator (such as modulator 36), which is located in headend 21 of television system 100 (FIG. 1). The block diagram is a representation of a modulator for modulating MPEG transport stream 302 (FIG. 3). The modulator 36 includes a multiplexer 410 for receiving and modifying an input signal 405. Modifying the input signal 405 includes extracting incoming MPEG table information. The modulator 36 may includes an encryptor 420 for encrypting the bit stream, a signal modulator 430 for modulating the bit stream, and an up converter 440 for producing output 445.

An Exemplary System for a Remote Control having a Print Button and the Supporting System

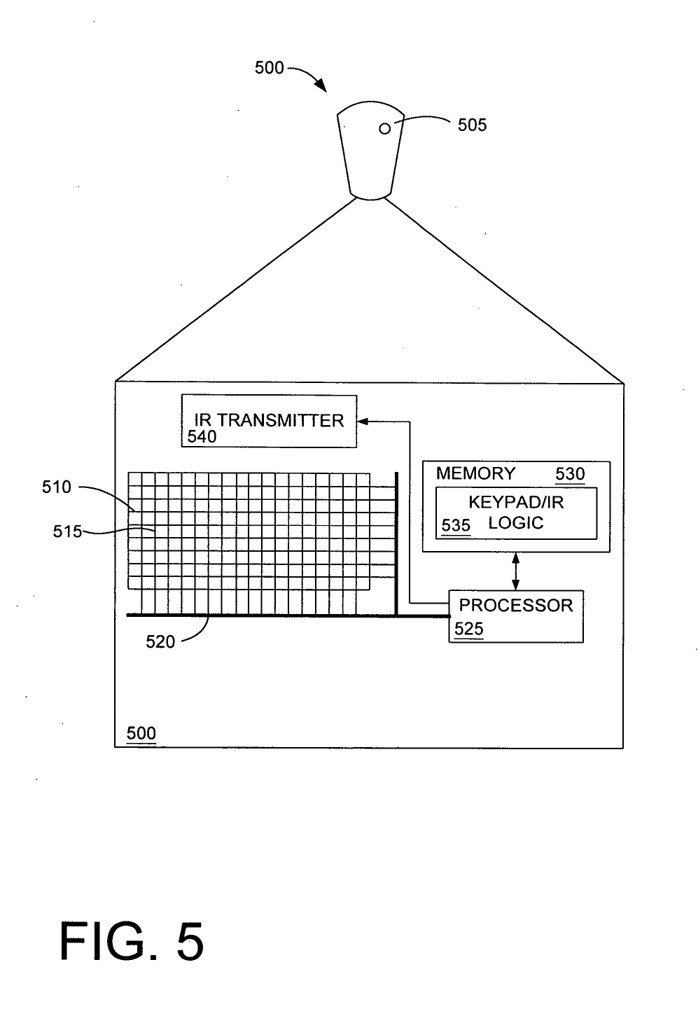

In an exemplary embodiment, the present invention provides a device that allows the subscriber to simply press a designated button on the remote control, thereby printing data that can be either displayed along with the event on a presentation device, such as a television, or not shown and embedded within the event that is available for printing to a connected printer. The printer can be connected either directly or through a network. Alternatively, the print button function can be added to a wireless IR keyboard. An example of a remote control is disclosed in commonly assigned U.S. patent application Ser. No. 09/457,881 filed Dec. 10, 1999, entitled “System and Method for Sending Multiple Infrared (IR) Data Packets using a Single Keypress”, the teachings of which are incorporated herein by reference. Referring now to the drawings, in which like numerals represent like elements throughout the several figures, the present invention and an exemplary operating environment will be described. FIG. 5 illustrates the IR remote control 500 including a print button 505 in accordance with the present invention. The print button 505 activates circuitry within the remote control 500, which is located at the intersection of horizontal lines 510 and vertical lines 515. When actuated, the print button associated with the intersection causes an electrical connection to be made at the intersecting lines. A signal is then sent via a communication bus 520 to a processor 525. The processor 525 analyzes the received signal and accesses a memory device 530. The memory device 530 includes a keypad IR logic 535 to determine which IR code corresponds to the print command. The processor 525 receives the IR code and then communicates with an IR transmitter 540 to send an appropriate IR signal that is indicative of the IR code to an IR receiver.

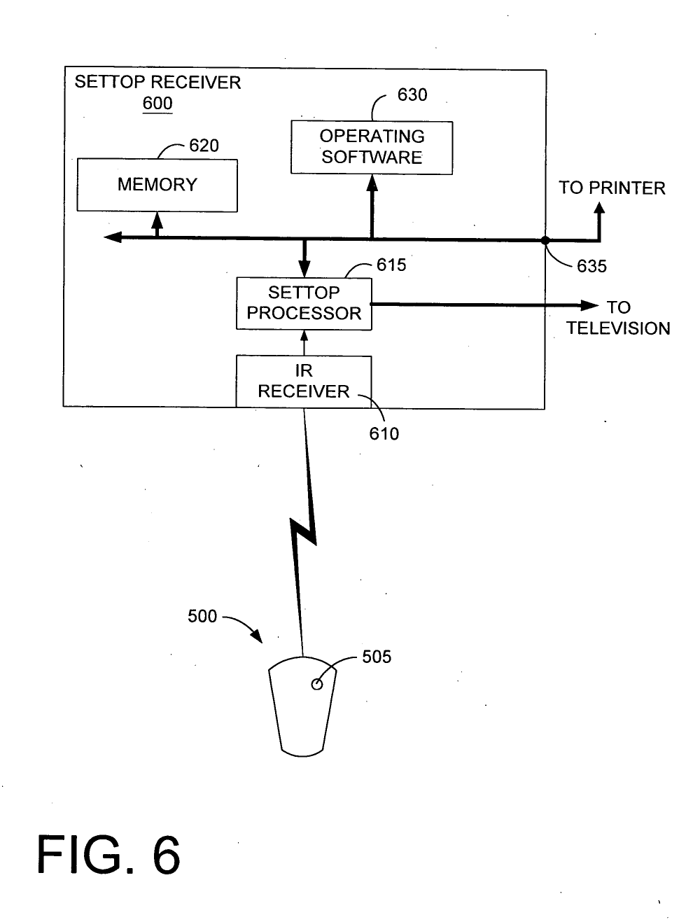

FIG. 6 is an electrical block diagram of a set-top receiver 600 that is controlled by the IR remote control 500 in accordance with the present invention. The IR receiver 610 within the set-top demodulates the received IR signal and transfers a serial bit data stream to a set-top processor 615. The set-top processor 615 decodes the serial bit data stream and stores a value, which is indicative of the print button command, in memory 620. After the value has been stored, the set-top processor 615 generates an interrupt, which informs operating software 630 that an IR event has been received. The operating software 630 then retrieves the register value from memory 620 and activates the required print action.

The print action includes accessing a database within the operating software 630 that includes some common print drivers associated with a standard printer, such as Hewlett-Packard or IBM printers. Alternatively, print drivers could also be included within a table that is sent in the MPEG data stream or similar repository, such as a carousel of drivers that are transmitted over a network or drivers retrieved from a repository on demand. The operating software 630 enables a printer (not shown) that is coupled to port 635. The printer is preferably coupled to port 635 by a universal serial bus (USB) connector or an International Electrical and Electronics Engineers (EEE) 1394 interface that is located on the set-top receiver 600, and is generally used as an auxiliary port for other external electronic devices. Alternatively, other types of interfaces could be used as long as the set-top and the printer are appropriately configured.

The transport stream associated with the event that is being shown on the television screen includes the data portion along with the video and audio portions in a typical cable television system. The receiver 600, which acts as a decoder, decodes the transport stream by identifying the PIDs associated with the program. Once the print button is activated and received in the IR receiver 610, the processor 615 diverts the data packets with the identified PID to have the headers removed by the usual process either by a demultiplexer/decoder or by the settop receiver processor. The resulting data is then rendered into printable format, which may differ from the format used for display on a television screen, and the printable format is then sent to the printer output port 635. The format changes required for a printable format are a function of the information transmitted and the specific printer used.

It will be appreciated that the data can be displayed on the television screen, or alternatively, does not have to be shown, but can be available as a subset of the program being shown. The data, such as a hypertext markup language (HTML) file, is included within a program or event. For example, a producer of a program may wish to send a recipe along with the normal viewing program to allow a subscriber to print the recipe data. Another example of embedded data may be instructions on how to repair a specific device. Printing the embedded data can be accomplished by displaying an icon on the viewing image alerting a subscriber that there is a data portion associated with the program that can be printed. The subscriber then simply presses the print button 505 on the remote control 500 and the operating software 630 then routes the embedded data portion, which is sent along with the video and audio portions of the program, captures the data in HTML or an alternative format, and sends the data to the connected printer.

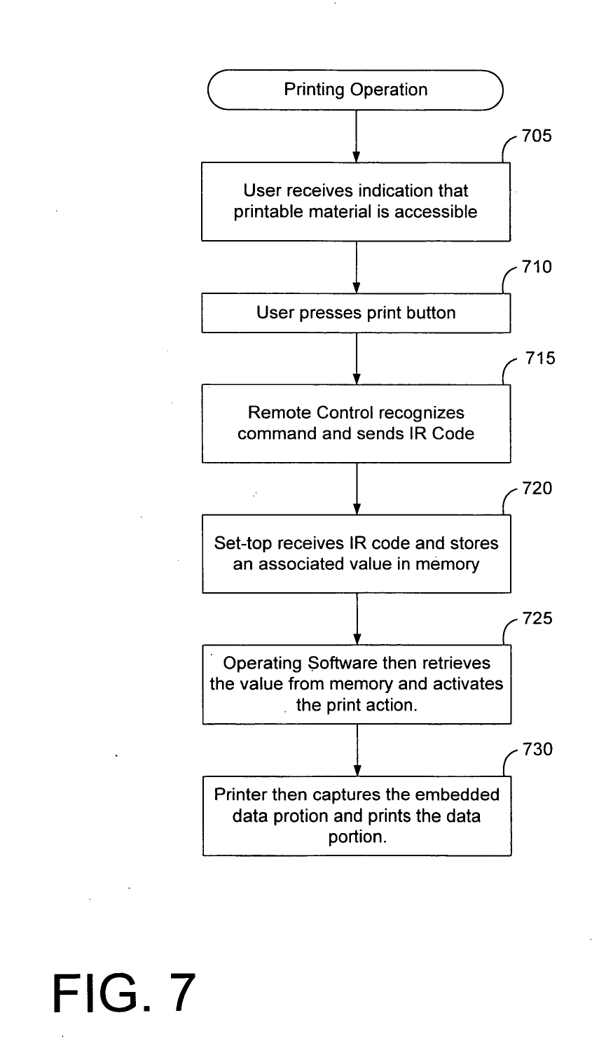

FIG. 7 is a flowchart depicting the printing operation. The printing operation begins at step 705 when the user receives an indication that printable material is accessible and available to print. In step 710, the user presses the print button on the remote control. The remote control then recognizes the command, and in step 715, the remote control sends an IR code that is indicative of the print command. In step 720, the set-top receiver receives the IR code and stores an associated value in memory. Operating software then receives an interruption that an event has been received, and in step 725, the operating software retrieves the value from memory and activates the print action. Finally, in step 730, the printer captures the embedded data portion and then prints the data portion of the event.

The exemplary embodiment of the present invention described herein is not intended to limit the application. It will be appreciated that a receiver can be a radio that conventionally receives audio signals. There could also be data signals that are provided to the radio receiver and that are available for printing. More specifically, the radio could include an output port for connecting with a printer. A remote control device that includes a print button in accordance with the present invention could then communicate with the receiver to print the available data that may be associated with the signals received at the radio. For example, if a provider wanted to send a playlist containing the list of music titles and authors for the next hour or coupons associated with a commercial that is being aired, the provider would send this information in a data format and trigger the listener of the available data that can be printed. In this manner, it will be appreciated that the print button is not associated with just the television viewing screen, but rather any receiver that receives information signals. Additionally, in systems other than cable television systems, the process remains fundamentally the same. For example, in an analog system, there is an application that can be implemented permitting the user to print the closed captioning data.

In summary, the print button 505 easily allows a subscriber to print embedded data portions of a program without the cable operator having to display the information. Additionally, the subscriber may print an advertisement that is being shown on the screen. Most subscribers have a printer at their homes currently, and can easily connect the printer with set-top receiver 510 via an appropriate interface on one end of the cable and the printer connection on the opposite end. Thus, the print button 505 on remote control 500 advantageously captures embedded data that is associated with an event being shown on the television via the set-top receiver 600 and then printed to a conventional printer.

Thus, a heretofore unaddressed need exists in the industry to address the aforementioned deficiencies and inadequacies.

1. A radio for receiving and delivering information, comprising:
a radio receiver for receiving audio signals and embedded data that is associated with the audio signals, the radio receiver further configured for receiving commands from a user; and
a printer interface configured to communicate information associated with the embedded data to a printer,
wherein upon reception of a command from the user, the information associated with the embedded data is provided to a printer for printing.

2. The radio of claim 1, further comprising a remote control unit, the remote control unit comprising a transmitter for providing the user commands to the radio.

3. The radio of claim 2, wherein the remote control unit is an infrared remote control having a print button function.

4. The radio of claim 1, wherein the printer interface comprises a printer port for providing the embedded data to an external printer upon command.

5. The radio of claim 1, further comprising a printer configured for receiving and printing the information associated with the embedded data.

6. The radio of claim 1, wherein the embedded data is associated with a coupon.

7. The radio of claim 1, wherein the embedded data is associated with a play list comprising a list of music titles and authors.

8. The radio of claim 8, wherein the play list comprises future songs configured to be played over a defined period of time.

9. The radio of claim 1, further configured for alerting the user of the presence of embedded data that is associated with information for printing.

10. The radio of claim 10, wherein alerting includes providing an audio signal detectable by a user.

11. A method for receiving data signals and delivering audio signals via a radio, the method comprising:
receiving a data signal comprising an audio portion and an embedded portion;
converting the audio portion of the data signal into an audio signal detectable by a user;
providing an indication of the presence of embedded data, the indication being detectable by the user;
receiving a print command from the user; and
printing at least a portion of the embedded data.

12. The method of claim 11, wherein printing at least a portion of the embedded data comprises sending at least a portion of the embedded data to an external printer.

13. The method of claim 11, wherein receiving a print command from a user comprises receiving a signal from a remote control unit.

14. The method of claim 13, wherein the remote control unit is an infrared remote control having a print button function.

15. The method of claim 13, wherein the remote control unit is a wireless infrared keyboard having a print button function.

16. The method of claim 11, wherein the embedded data is associated with a coupon.

17. The method of claim 11, wherein the embedded data is associated with a play list comprising music titles and authors.

18. The method of claim 18, wherein the play list comprises future songs configured to be played over a defined period of time.

19. The method of claim 11, wherein the indication comprises an audio signal detectable by the user.
